(19) United States
(12) Patent Application Publication
(10) Pub. No.: US 2021/0278532 A1
(43) Pub. Date: Sep. 9, 2021

(54) WIRELESS TRANSCEIVER DEVICE AND ELECTRONIC DEVICE USING THE SAME

(71) Applicant: WT Microelectronics Co., Ltd., New Taipei City (TW)

(72) Inventor: Shih-Tien FENG, New Taipei City (TW)

(21) Appl. No.: 17/193,797

(22) Filed: Mar. 5, 2021

(30) Foreign Application Priority Data
Mar. 6, 2020 (TW) 109107401

(51) Int. Cl. G01S 17/08; G02B 5/04; G02B 5/22

(52) U.S. Cl. CPC G01S 17/08; G02B 5/223; G02B 5/04

(57) ABSTRACT

A wireless transceiver device includes a wireless transceiver component and a physical medium. The wireless transceiver component has a transceiver surface. The physical media is disposed on the transceiver surface.

This application claims the benefit of Taiwan application Serial No. 109107401, filed Mar. 6, 2020, the subject matter of which is incorporated herein by reference.

### BACKGROUND OF THE INVENTION

### Field of the Invention

The present disclosure relates to a transceiver element and an electronic device using the same, and more particularly to a wireless transceiver element and an electronic device using the same.

### Description of the Related Art

The conventional wireless transceiver element disposed on a housing of an electronic device and the housing are separated by an air layer, detection light emitted by the wireless transceiver element is emitted out of the housing through this air layer, and reflected light of the detection light being reflected from a to-be-tested object passes through the air layer and enters the wireless transceiver element. However, this air layer will change angles of the detection light and the reflected light, so that not all the reflected light received by the wireless transceiver element is reflected from the to-be-tested object. For example, a part of the detection light is scattered through the housing or reflected back to be received by the wireless transceiver element before it is incident on the to-be-tested object. Such part of the detection light causes noise to the wireless transceiver element, and thus the accuracy of the data calculated based on the reflected light received by the wireless transceiver element is reduced.

### SUMMARY OF THE INVENTION

The embodiment of the present invention is to provide a wireless transceiver device and an electronic device using the same capable of resolving the above problem.

According to an embodiment of the present invention, a wireless transceiver device is provided. The wireless transceiver device includes a wireless transceiver element and a physical medium. The wireless transceiver element has a transceiving surface. The physical medium is disposed on the transceiving surface.

According to another embodiment of the present invention, an electronic device is provided. The electronic device includes a casing and a wireless transceiver element. The wireless transceiver device is disposed on the casing and includes a wireless transceiver element and a physical medium. The wireless transceiver element has a transceiving surface. The physical medium is disposed on the transceiving surface.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A is a partial cross-sectional view of an electronic device according to an embodiment of the present invention;

FIG. 1B is a top view of the electronic device of FIG. 1A;

FIG. 2A is a partial cross-sectional view of the electronic device according to another embodiment of the present invention;

FIG. 2B is a top view of the electronic device of FIG. 2A;

FIG. 3 shows a partial cross-sectional view of an electronic device according to another embodiment of the present invention;

FIG. 4 shows a cross-sectional view of the wireless transceiver element of FIG. 1A;

FIG. 5 shows a schematic diagram of the first photorefractive element of the wireless transceiver element of FIG. 4;

FIG. 6 is a schematic diagram of the electronic device configured with the wireless transceiver element of FIG. 4;

FIG. 7 illustrates a cross-sectional view of another type of the wireless transceiver element according to an embodiment of the present invention;

FIG. 8 shows relationship curve between the thickness of the physical medium of FIG. 1A and the noise; and

FIG. 9 shows the relationship curve between the thickness of the physical medium of FIG. 2A and the noise.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

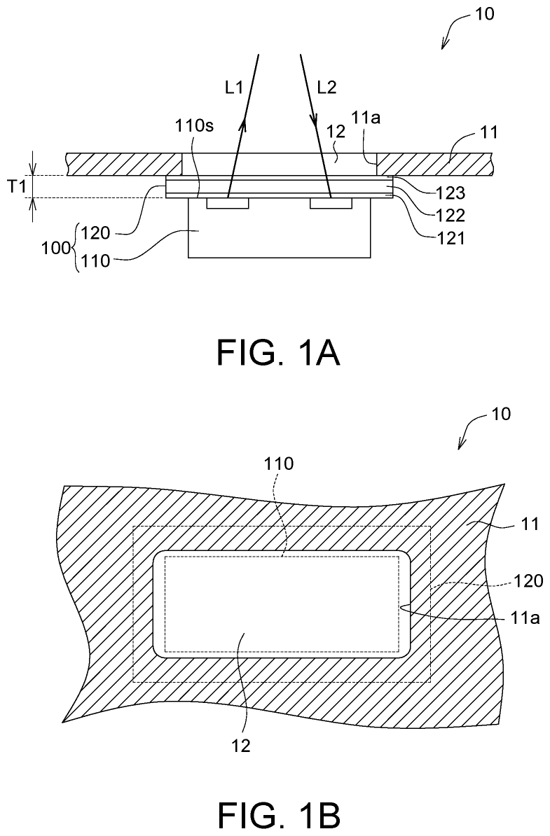

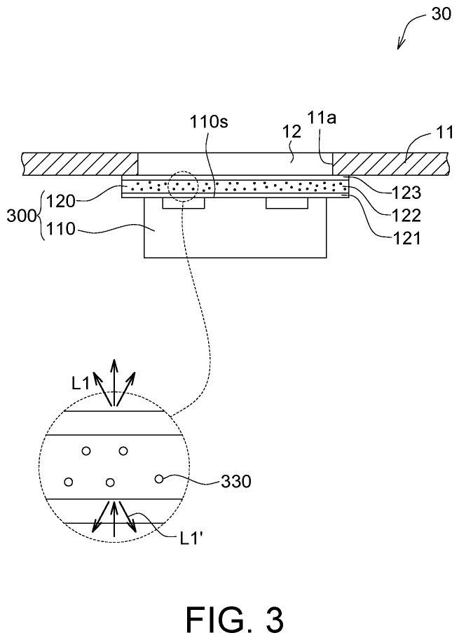

Referring to FIGS. 1A and 1B, FIG. 1A is a partial cross-sectional view of an electronic device 10 according to an embodiment of the present invention, and FIG. 1B is a top view of the electronic device 10 of FIG. 1A. The electronic device 10 is, for example, a notebook computer or other devices that require a wireless transceiver device 100. The electronic device 10 includes a casing 11, a light-transmitting cover 12 and a wireless transceiver 100. The casing 11 has a through hole 11a, and the light-transmitting cover 12 is disposed in the through hole 11 a to protect the wireless transceiver device 100 located in the casing 11. In another embodiment, the casing 11 is, for example, a light-transmitting casing, which could be coated with a light-shielding layer (such as ink) to form a light-shielding area (corresponding to the cross-sectional area of the casing 11 in FIG. 3) while the area without being coated with light-shielding layer forms a light-transmitting area (corresponding to the area of the through hole 11a in FIG. 3). In this example, the housing 11 does not need to form the through hole 11a and does not need to be provided with the light-transmitting cover 12.

The wireless transceiver device 100 includes a wireless transceiver element 110 and a physical medium 120. The wireless transceiver element 110 has a transceiving surface 110s. The physical medium 120 is disposed on the transceiving surface 110s. The wireless transceiver element 110 emits a detection light L1, and the detection light L1 is reflected from a to-be-tested object (not shown) to become a reflected light L2, and the reflected light L2 is received by the wireless transceiver element 110. The wireless transceiver element 100 is, for example, a ranging device, such as a Time of Flight (ToF) device. The wireless transceiver element 110 obtains distance between the wireless transceiver device 100 and the to-be-tested object based on (or by calculating) the phase difference between the detection light L1 and the reflected light L2, or obtains the distance between the wireless transceiver device 100 and the to-be-tested object based on (or by calculating) the light speed and the light flight time (e.g., distance=light speed xlight flight time). In addition, the detection light L1 is, for example, infrared light or other light that could be used for distance measurement.

Compared with the air layer between the conventional wireless transceiver device and the light-transmitting cover, the physical medium 120 of the embodiment of the present invention could reduce light noise to increase the accuracy of the measured distance. The “noise” herein refers to any signal that will negatively affect the accuracy of the output value (such as the measured distance) of the wireless transceiver device 100, such as cross-talk (cross-talk interference) signals.

The physical medium 120 could allow the detection light L1, with the wavelength band of a specific wavelength range, to pass through, and allow the reflected light L2, with the wavelength band of a specific wavelength range, to pass through. The specific wavelength range includes, for example, a wavelength of 940 nanometers (nm). Since the physical medium 120 could filter out light outside a specific wavelength range, it could increase the accuracy of the measured distance.

The physical medium 120 is made of, for example, a filter material, which could filter out light outside a specific wavelength range. In another embodiment, the physical medium 120 could absorb or scatter light outside a specific wavelength range, but allow light with a specific wavelength range to pass through, thereby increasing the accuracy of the measured distance.

In an embodiment, the refractive index of the physical medium 120 is greater than 1 (larger than refractive index of air). As a result, the amount of light reflected back to the physical medium 120, when the detection light L1 is incident on the interface between the physical medium 120 and the light-transmitting cover 12, could be reduced. The light reflected back to the physical medium 120 is reflected back and forth within the physical medium 120 to become noise light. Since the noise light is not the light that is reflected from the to-be-tested object, it will negatively affect the accuracy of the measured distance. However, since the refractive index of the physical medium 120 in the present embodiment is greater than 1, the amount of noise light could be effectively reduced (noise reduction) to increase the accuracy of the measured distance.

In addition, compared with the distance (air layer) between the conventional wireless transceiver device and the light-transmitting cover, the thickness T1 of the physical medium 120 is smaller, and thus it is conducive the space matching and/or assembling of the wireless transceiver device 100 in the casing 11. In addition, the conventional wireless transceiver device is disposed on the casing by means of a mechanism engagement method. Such mechanism combination method results in a relatively large distance (air layer) between the wireless transceiver device and the light-transmitting cover. Since the physical medium 120 could be made of light-transmitting glue, the distance between the wireless transceiver 100 and the light-transmitting cover 12 (the thickness T1 of the physical medium 120) could be effectively reduced, and it is conducive the space matching and/or assembling of the wireless transceiver device 100 in the casing 11.

As shown in FIG. 1A, the physical medium 120 includes a first adhesive layer 121, a dielectric layer 122 and a second adhesive layer 123. The first adhesive layer 121 and the second adhesive layer 123 are respectively adhered to two opposite sides of the dielectric layer 122. The first adhesive layer 121 could bond the wireless transceiver device 100 and the dielectric layer 122, and the second adhesive layer 123 could bond the casing 11 and the dielectric layer 122. In another embodiment, when the dielectric layer 122 itself has adhesiveness, the physical medium 120 could omit at least one of the first adhesive layer 121 and the second adhesive layer 123. The first adhesive layer 121, the dielectric layer 122 and the second adhesive layer 123 are light-transmitting (transparent) layers to allow light to pass through. In an embodiment, the physical medium 120 is, for example, OCA (Optically Clear Adhesive). The dielectric layer 122 is made of, for example, acrylic material, which could achieve the aforementioned technical effect of noise reduction.

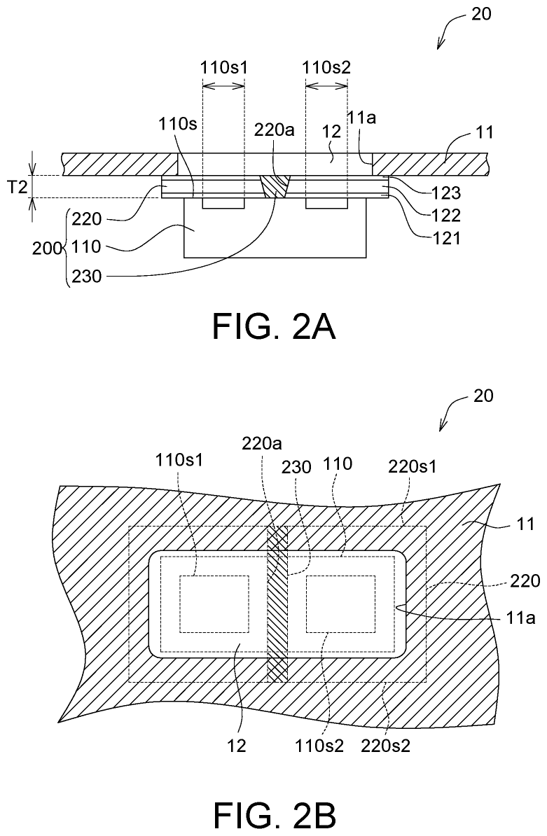

Referring to FIGS. 2A and 2B, FIG. 2A is a partial cross-sectional view of the electronic device 20 according to another embodiment of the present invention, and FIG. 2B is a top view of the electronic device 20 of FIG. 2A. The electronic device 20 is, for example, a notebook computer or other devices that require a wireless transceiver 200. The electronic device 20 includes the casing 11, the light-transmitting cover 12 and a wireless transceiver 200.

As shown in FIG. 2A, the wireless transceiver device 200 includes the wireless transceiver element 110, a physical medium 220 and a spacer element 230. The physical medium 220 is disposed on the transceiving surface 110s of the wireless transceiver element 110. The wireless transceiver device 200 in the embodiment of the present invention has the structure similar to the wireless transceiver device 100, except that the wireless transceiver device 200 further includes a spacer element 230.

Furthermore, the transceiving surface 110s includes a transmitting area 110s1 and a receiving area 110s2. The spacer element 230 is embedded in the physical medium 220 and located between the transmitting area 110s1 and the receiving area 110s2, which could block the detection light L1 and the reflected light L2 and prevent the detection light L1 reflected within the physical medium 220 from being incident on the receiving area 110s2 of the wireless transceiver element 110. In an embodiment, the spacer element 230 is a non-transparent element, which has the effect of blocking light penetration. Specifically, the spacer element 230 is, for example, made of polycarbonate (PC), poly(methyl methacrylate) (PMMA) or other opaque materials, such as opaque plastic material.

In addition, the refractive index of the spacer element 230 is different from the refractive index of the physical medium 220, for example, the refractive index of the spacer element 230 is greater than the refractive index of the physical medium 220. Alternatively, the spacer element 230 itself is made of a light-absorbing material, which could absorb the detection light L1 incident on the spacer element 230 within the physical medium 220, and prevent the detection light L1 reflected in the physical medium 220 from being incident on the receiving area 110s2 of the wireless transceiver device 110.

As shown in FIG. 2A, the physical medium 220 has the structure the same as or similar to that of the physical medium 120, except that the physical medium 220 has a through groove 220a. The spacer element 230 fills the entire through groove 220a, which could prevent any air layer from being generated. In another embodiment, the spacer element 230 could be omitted from the wireless transceiver device 200. In this example, the through groove 220a is an air layer, and the refractive index is equal to 1. As a result, it could also be avoided that the detection light L1 within the physical medium whose the incident angle is larger than total reflection angle travels through the through groove 220a to refracted to the receiving area 110s2 of the wireless transceiver element 110.

As shown in FIG. 2A, due to the through groove 220a penetrating the physical medium 220, the spacer element 230 extends to the transceiving surface 110s of the wireless transceiver element 110 from the light-transmitting cover 12, that is, the spacer element 230 contacts the light-transmitting cover 12 and the wireless transceiver element 110, and thus it could completely block the detection light L1 within the physical medium 220 from being incident on the receiving area 110s2 of the wireless transceiver element 110.

As shown in FIG. 2B, the through groove 220a extends between the opposite first side 220s1 and the second side 220s2 of the physical medium 220. For example, the through groove 220a extends to the second side 220s2 from the first side 220s1. The extending length of the through groove 220a is greater than the length of the wireless transceiver element 110 along the extending direction of the through groove 220a, so that the spacer element 230 filling the through groove 220a could completely block the transmitting area 110s1 and the receiving area 110s2.

Referring to FIG. 3, FIG. 3 shows a partial cross-sectional view of an electronic device 30 according to another embodiment of the present invention. The electronic device 30 is, for example, a notebook computer or other devices that require a wireless transceiver device 300. The electronic device 30 includes the casing 11, the light-transmitting cover 12 and a wireless transceiver 300.

As shown in FIG. 3, the wireless transceiver device 300 includes the wireless transceiver element 110, the physical medium 120 and a plurality of filter particles 330. The physical medium 120 is disposed on the transceiving surface 110s of the wireless transceiver element 110. The wireless transceiver device 300 of the embodiment of the present invention has structure similar to that of the wireless transceiver device 100, except that the wireless transceiver device 300 further includes a plurality of filter particles 330. The filter particles 330 are, for example, ink particles. The filter particles 330 are doped in the physical medium 120, for example, doped in the dielectric layer 122 to increase the light intensity. When light is incident on the filter particles 330, part of the light is reflected and part of the light is refracted. Compared with the embodiment in which the filter particles 330 are omitted in the physical medium 120, as shown in FIG. 3, the reflected light L1′ of the embodiment of the present invention is reduced, and it means that the noise is reduced (the light reflected within the physical medium 120 may cause noise). In addition, the reduction of the reflected light L1′ means that the output energy of the detection light L1 is increased, and the light intensity along the optical axis becomes larger, so the light intensity of the reflected light L2 received by the wireless transceiver element 110 could be increased, thereby increasing the accuracy of the measured distance.

In the present embodiment, as shown in FIG. 3, the light-transmitting cover 12 could not be doped with filter particles 330, or the surface of the light-transmitting cover 12 could not be coated with filter particles 330, but the embodiment of the present invention is not limited by this. When the filter particles 330 are coated on the surface of the light-transmitting cover opposite to the physical medium 120, the surface roughness of the light-transmitting cover will increase, and it causes the amount of light reflected from the light-transmitting cover 12 to increase and thus noise to increase. In contrast to the wireless transceiver device 300 of the embodiment of the present invention, since the filter particles 330 are doped in the physical medium 120, the filter particles 330 would not increase the surface roughness of the physical medium 120, and therefore it could effectively improve the aforementioned problem of noise.

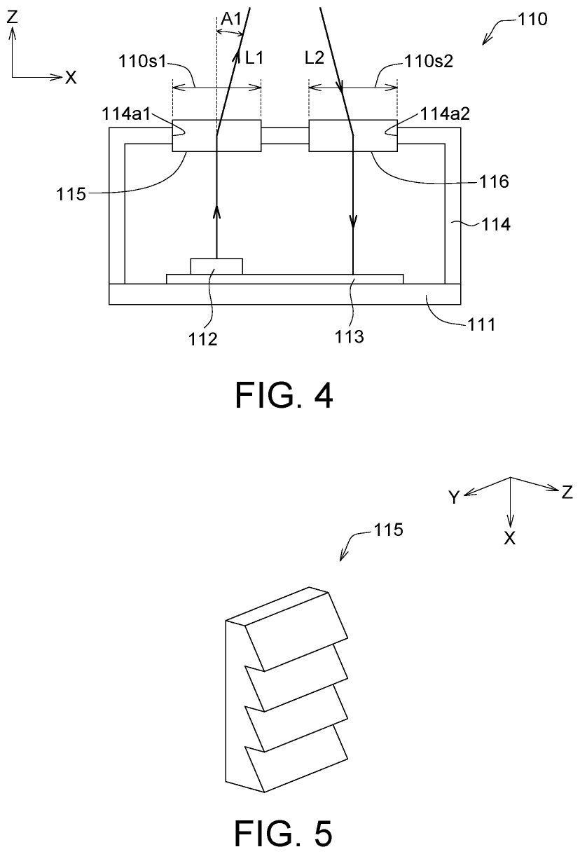

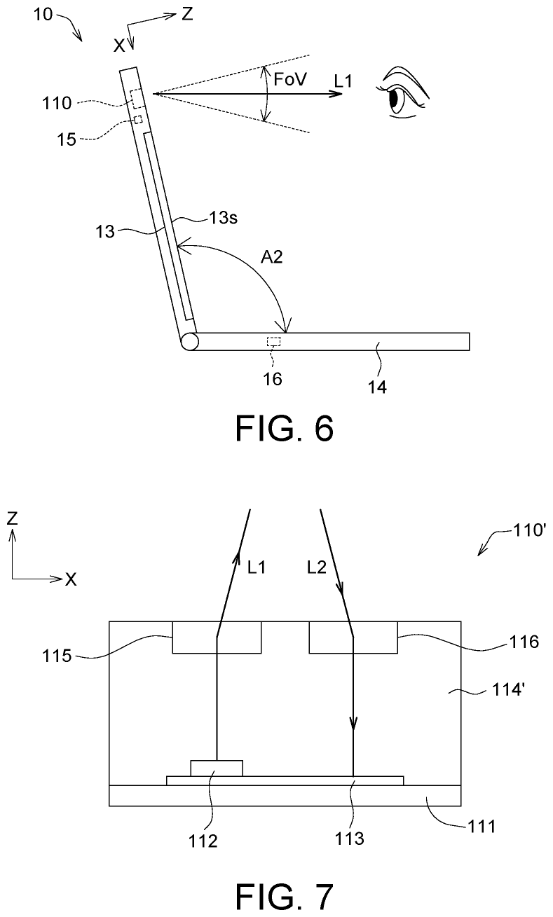

Referring to FIGS. 4 to 6, FIG. 4 shows a cross-sectional view of the wireless transceiver element 110 of FIG. 1A, FIG. 5 shows a schematic diagram of the first photorefractive element 115 of the wireless transceiver element 110 of FIG. 4, and FIG. 6 is a schematic diagram of the electronic device 10 configured with the wireless transceiver element 110 of FIG. 4.

In the present embodiment, the wireless transceiver element 110 is, for example, an OLGA (Organic Land Grid Array) type package. As shown in FIG. 4, the wireless transceiver element 110 includes a circuit board 111, a light-emitting element (for example, transparent element) 112, a receiving circuit 113, a frame 114, a first photorefractive element 115 and a second photorefractive element 116. The wireless transceiver element 110 includes the transceiving surface 110s, and the transceiving surface 110s includes a transmitting area 110s1 and a receiving area 110s2. The wireless transceiver element 110 is configured for emitting the detection light L1 from the emitting area 110s1, the detection light L1 is reflected by the to-be-tested object (not shown) and becomes the reflected light L2, and the reflected light L2 is incident on the receiving area 110s2. As shown in the figure, the range of the first photorefractive element 115 defines the emitting area 110s1, and the range of the second photorefractive element 116 defines the receiving area 110s2.

The light-emitting element 112 and the receiving circuit 113 are disposed on and electrically connected to the circuit board 111. The light-emitting element 112 is configured to emit the detection light L1, and the receiving circuit 113 is configured to receive the reflected light L2. In an embodiment, the light-emitting element 112 is, for example, a Vertical-Cavity Surface-Emitting Laser (VCSEL) or a light-emitting diode, but the embodiment of the present invention does not limit the type of the light-emitting element 112. The receiving circuit 113 is, for example, an Application Specific Integrated Circuit (ASIC), but the embodiment of the present invention is not limited thereto. The frame 114 is disposed on the circuit board 111 and covers the light-emitting element 112 and the receiving circuit 113 to protect these components. In the present embodiment, there is an air layer between the frame 114, the photorefractive elements (the first photorefractive element 115 and the second photorefractive element 116), the light-emitting element 112 and the receiving circuit 113, that is, the frame 114 is not filled with any packaging materials. In addition, the frame 114 has a first through hole 114a1 and a second through hole 114a2, and the first photorefractive element 115 and the second photorefractive element 116 are respectively disposed within the first through hole 114a1 and the second through hole 114a2.

As shown in FIG. 5, the first photorefractive element 115 is, for example, a prism, but the embodiment of the present invention is not limited to this. As long as the structure that could change the light angle, it could be applied as the first photorefractive element 115 of the present embodiment of the present invention. In addition, the material of the first photorefractive element 115 could include silicide, or the material of the first photorefractive element 115 allows the detection light L1 to pass through. For example, the first photorefractive element 115 is a light-transmitting plate doped with particles that allow the detection light L1 to travel through, or the first photorefractive element 115 is entirely made of a material that allows the detection light L1 to travel through. The second photorefractive element 116 has material and/or structure similar to or the same as that of the first photorefractive element 115, and it will not be repeated here.

As shown in FIG. 6, the electronic device 10 is, for example, a notebook computer. The wireless transceiver element 110 could be disposed in the casing 11 of the electronic device 10, and the casing 11 is, for example, a casing of the screen 13 of the electronic device 10. As shown in FIG. 6, although a display surface 13s of the screen 13 does not directly face the user, since the first and second photorefractive elements 115 and 116 could change the light angle, the field of view (FoV) of the detection light L1 still includes any part of the user's body, such as eyes, but not limited to eyes. In addition, the aforementioned field of view includes, for example, a horizontal orientation.

As shown in FIG. 6, the angle between a host 14 and the screen 13 of the electronic device 10 is A2. Taking the refractive angle of the wireless transceiver element 110 as A1 (refractive angle A1 is shown in FIG. 4), for example, when the angle A2 between the host 14 and the screen 13 of the electronic device 10 is approximately equal to (90 degree+A1), the detection light L1 could be incident horizontally to any part of the user's body, such as the face or eyes. In an embodiment, the electronic device 10 further includes an orientation detector 15 disposed on the screen 13 and configured to detect orientation of the screen 13. The orientation detector 15 is, for example, an acceleration sensor, a gyroscope, or a sensor capable of detecting the orientation of the screen 13. The electronic device 10 further includes a processor 16 disposed on the host 14. The processor 16 could obtain the orientation of the screen 13 relative to the host 14, such as the angle A2 of the screen 13 relative to the host 14, based on detection signal of the orientation detector 15. As a result, when the included angle A2 between the host 14 and the screen 13 of the electronic device 10 is substantially equal to (90°+A1), the processor 16 could control an indicator (not shown) to send out an indication signal (not shown) to let user know that the angle A2 is substantially or roughly equal to (90°+A1). The aforementioned indicator is, for example, a speaker, a light emitter, a vibrator, a display, or any other element that could emit the indication signal.

Referring to FIG. 7, FIG. 7 illustrates a cross-sectional view of another type of the wireless transceiver element 110′ according to an embodiment of the present invention. The wireless transceiver element 110′ includes the circuit board 111, the light-emitting element 112, the receiving circuit 113, a package body 114′, a first photorefractive element 115 and a second photorefractive element 116. The wireless transceiver element 110′ of the embodiment of the present invention has the feature same as or similar to that of the aforementioned wireless transceiver element 110, except that the package 114′ of the wireless transceiver element 110′ covers and contacts the circuit board 111, the light-emitting element 112 and the receiving circuit 113.

The packaging body 114′ is, for example, a light-transmitting packaging material. As shown in the figure, the first optical refraction element 115 and the second optical refraction element 116 could be embedded in the package body 114′.

In addition, the wireless transceiver element 110 of the electronic device 10 of FIG. 6 could be replaced by the wireless transceiver element 110′ of FIG. 7, which could still achieve similar or the same technical effects as mentioned above.

Referring to FIG. 8, FIG. 8 shows relationship curve between the thickness T1 of the physical medium 120 of FIG. 1A and the noise. The axis of abscissa in the figure represents the distance between the light-transmitting cover 12 and the wireless transceiver element 110. As shown FIG. 1A, the distance is the thickness T1 of the physical medium 120 (the thickness T1 is shown in FIG. 1A). The axis of ordinate in the figure represents relative total power, which could represent the noise energy received by the receiver. The smaller the relative total energy is, the smaller the noise is; on the contrary, the larger the relative total energy, the larger the noise is. The curve C1 in the figure represents the relationship between the thickness T1 of the physical medium 120 of FIG. 1A and the noise, and the curve C2 represents the distance and noise relationship between the light-transmitting cover 12 and the wireless transceiver element 110 under omitting the physical medium 120 of FIG. 1A. Due to the physical medium 120, the noise could be effectively reduced. Compared with the curve C2, when the thickness T1 of the physical medium 120 ranges between 200 μm and 600 μm (curve C1), the noise is reduced by about 25% to about 50%.

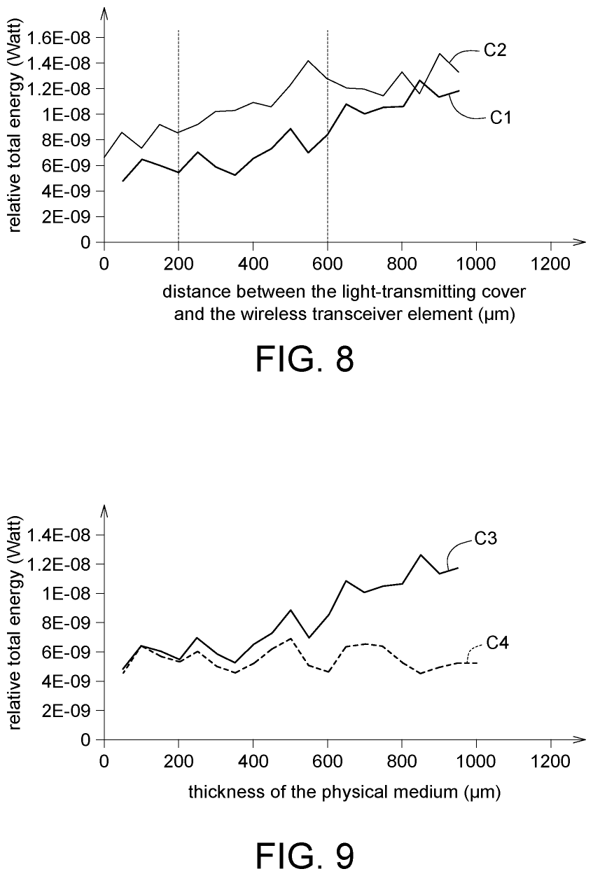

Referring to FIG. 9, FIG. 9 shows the relationship curve between the thickness T1 of the physical medium 220 of FIG. 2A and the noise. The axis of abscissa in the figure represents the thickness of the physical medium, and the axis of ordinate in the figure represents the relative total energy. The curve C3 in the figure represents the relationship between the thickness T1 of the physical medium 120 of FIG. 1A (thickness T1 is shown in FIG. 1A) and noise, and the curve C4 represents the thickness T2 of the physical medium 220 of FIG. 2A (the thickness T2 is shown in FIG. 2A) and noise. Compared to the physical medium 120 without the spacer element 230 (curve C3), due to the physical medium 220 being provided with the spacer element 230 (curve C4), the noise could be reduced more effectively. Compared with curve C3, when the thickness T1 of the physical medium 220 ranges between 200 micrometers and 1000 micrometers (curve C4), the noise reduction ratio gradually increases in a direction from 200 micrometers to 1000 micrometers, and the maximum reduction is at least 50%.

In summary, the wireless transceiver of the embodiment of the present invention at least includes a physical medium, which could filter, absorb or scatter parts of the detection light L1 outside the specific wavelength range, thereby increasing the accuracy of the measured distance. In addition, the physical medium could also filter, absorb, or scatter the reflected light that is not reflected by the to-be-tested object to reduce the reflected light that is not reflected by the to-be-tested object, and thus it could negatively affect the accuracy of the measured distance.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless transceiver device, comprises:
a wireless transceiver element having a transceiving surface; and
a physical medium disposed on the transceiving surface.

2. The wireless transceiver device according to claim 1, wherein physical medium touches the receiving surface.

3. The wireless transceiver device according to claim 1, wherein the physical medium has a thickness ranging between 200 μm and 600 μm.

4. The wireless transceiver device according to claim 1, wherein the transceiving surface comprises a transmitting area and a receiving area, and the wireless transceiving device further comprises:
a spacer element embedded in the physical medium and located between the transmitting area and the receiving area.

5. The wireless transceiver device according to claim 1, wherein the physical medium has a thickness ranging between 200 μm and 1000 μm.

6. The wireless transceiver device according to claim 4, wherein the spacer element is a non-transparent element.

7. The wireless transceiver device according to claim 1, further comprises:
a plurality of filter particles doped in the physical medium.

8. The wireless transceiver device according to claim 1, wherein the transceiving surface comprises a transmitting area and a receiving area, and the wireless transceiver element is configured to emit light from the transmitting area, and the light reflected by a to-be-tested object is incident to the receiving area; the wireless transceiving device further comprises:
a first photorefractive element located on optical path where the light exits from the transmitting area; and
a second photorefractive element located on the optical path where the light is reflected to the receiving area.

9. An electronic device, comprises:
a casing; and
a wireless transceiver device disposed on the casing and comprises:
a wireless transceiver element having a transceiving surface; and
a physical medium disposed on the transceiving surface.

10. The electronic device according to claim 9, wherein physical medium touches the receiving surface.

11. The electronic device according to claim 9, wherein the physical medium has a thickness ranging between 200 μm and 600 μm.

12. The electronic device according to claim 9, wherein the transceiving surface comprises a transmitting area and a receiving area, and the wireless transceiving device further comprises:
a spacer element embedded in the physical medium and located between the transmitting area and the receiving area.

13. The electronic device according to claim 12, wherein the physical medium has a thickness ranging between 200 μm and 1000 μm.

14. The electronic device according to claim 12, wherein the spacer element is a non-transparent element.

15. The electronic device according to claim 9, further comprises:
a plurality of filter particles doped in the physical medium.

16. The electronic device according to claim 9, wherein the transceiving surface comprises a transmitting area and a receiving area, and the wireless transceiver element is configured to emit light from the transmitting area, and the light reflected by a to-be-tested object is incident to the receiving area; the wireless transceiving device further comprises:
a first photorefractive element located on optical path where the light exits from the transmitting area; and
a second photorefractive element located on the optical path where the light is reflected to the receiving area.
